(19) United States
(12) Patent Application Publication
(10) Pub. No.: US 2011/0155882 A1
(43) Pub. Date: Jun. 30, 2011

(54) MOUNTING APPARATUS FOR DISK DRIVE

(75) Inventor: ZHI-PING WU, Shenzhen City (CN)

(73) Assignees: HONG FU JIN PRECISION INDUSTRY(ShenZhen) CO., LTD., Shenzhen City (CN); HON HAI PRECISION INDUSTRY CO., LTD., Tu-Cheng (TW)

(21) Appl. No.: 12/784,717

(22) Filed: May 21, 2010

(30) Foreign Application Priority Data
Dec. 25, 2009 (CN) 200920318501.9

(51) Int. Cl. F16M 13/00

(52) U.S. Cl. 248/309.1

(57) ABSTRACT

A mounting apparatus includes a bracket and a locking member. The bracket is configured for receiving a disk drive and includes a side plate. The side plate defines two through holes. The locking member is secured to the side plate and includes a locking portion and two locking posts. The locking portion is resiliently deformable. The two locking posts are secured to the locking portion. The locking member has an unlocked position, where the locking portion is resiliently deformed and the two locking posts are disengaged from the bracket, and a locked position, where the locking portion is in an original state and inserts the two locking posts into the bracket through the two through holes, for engaging in fixing holes defined in the disk drive.

### BACKGROUND

1. Technical Field

The present disclosure relates to a mounting apparatus for securing a disk drive in a bracket.

2. Description of Related Art

A locking member is usually secured to a bracket that receives a disk drive. Two tabs extend from the locking member. Two through holes are defined in the bracket. The tabs are capable of being inserted into the through holes and engaged in fixing holes defined in the disk drive, to secure the disk drive in the bracket. However, a joint between each tab and the locking member is too easily ruptured.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded view of a mounting apparatus and a disk drive in accordance with an embodiment.

FIG. 2 is an exploded view of a locking member of FIG. 1.

FIG. 3 is an assembled view of the mounting apparatus and the disk drive of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

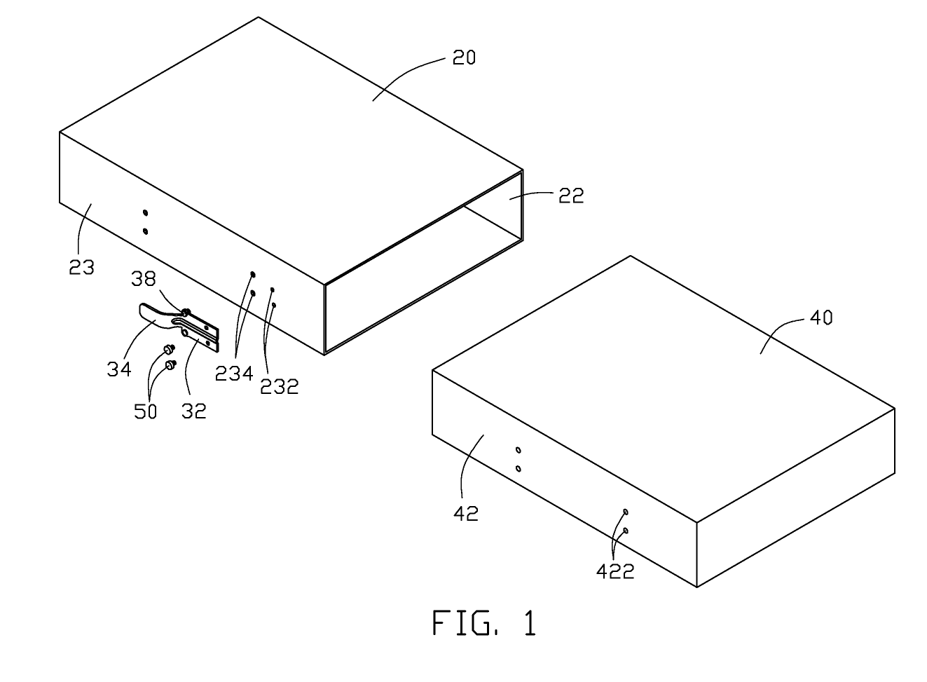

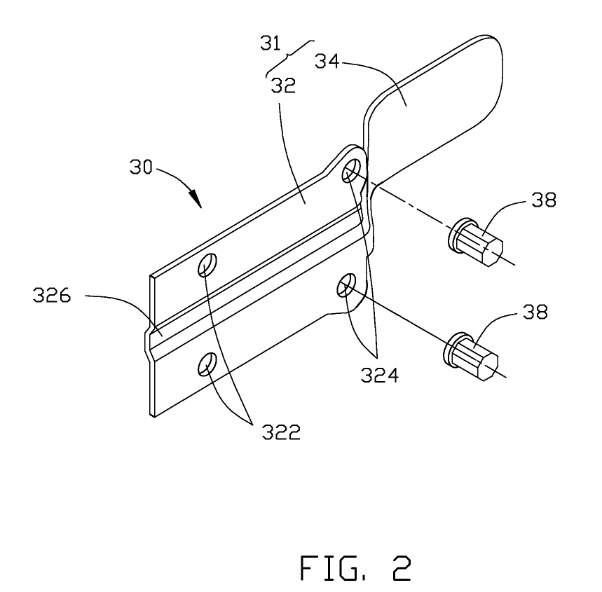

Referring to FIG. 1, a mounting apparatus in accordance with an embodiment is configured for securing a disk drive 40. The disk drive 40 includes two opposite sidewalls 42. Each sidewall 42 defines a plurality of fixing holes 422. The disk drive 40 may be, for example, a hard disk drive or a CD-ROM drive. The mounting apparatus includes a bracket 20 for receiving the disk drive 40 and a locking member 30 (shown in FIG. 2) for securing the disk drive 40 in the bracket 20.

The bracket 20 includes two side plates 22, 23. The side plate 23 defines a plurality of through holes 234 and two fastening holes 232.

Referring to FIG. 2, the locking member 30 includes a locking piece 31 and two locking posts 38 secured to the locking piece 31. The locking piece 31 includes a resiliently deformable locking portion 32 and an operating portion 34 extending from the locking portion 32. The locking portion 32 defines two securing holes 322 and two mounting holes 324. A convex portion 326 is located on the locking portion 32 between the two securing holes 322 and between the two mounting holes 324 and protrudes from an outside surface of the locking portion 32. The convex portion 326 is capable of preventing damage to the locking portion 32 when the locking portion 32 is resiliently deformed. In an embodiment, the convex portion 326 extends to the operating portion 34. The locking posts 38 are fixed into the mounting holes 324, such as by riveting. In an embodiment, each locking post 38 has a circular cross-section, to increase surface area engaging with the disk drive 40. In another embodiment, each locking post 38 has a polygon cross-section.

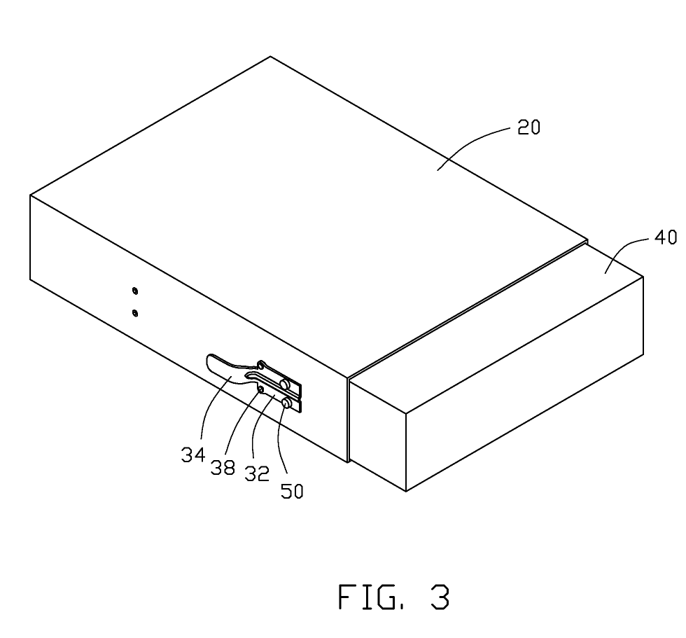

Referring FIGS. 1-3, the locking member 30 is attached to an outer surface of the side plate 23 of the bracket 20. The locking posts 38 are inserted into the bracket 20 through the through holes 234, and the securing holes 322 correspond to the fastening holes 232. Two fasteners 50, such as screws or bolts, are secured into the securing holes 322 and the fastening holes 232, to secure the locking member 30 to the side plate 23 of the bracket 20.

The locking member has an unlocked position, where the locking portion 32 is resiliently deformed to disengage the locking posts 38 from the bracket 20, and a locked position, where the locking posts 28 are engaged in the bracket 20 and the locking portion 32 is in an original state, to enable the disk drive 40 to be inserted into the bracket 20.

In assembly of the disk drive 40, the operating portion 34 of the locking member 30 is operated outwardly to resiliently deform the locking portion 32 until the locking member 30 is in the unlocked position. The disk drive 40 is inserted into the bracket 20, and the fixing holes 422 of the disk drive 40 correspond to the through holes 234 of the bracket 20. The operating portion 34 is released, and the locking portion 32 rebounds until the locking member 30 is in the locked position. The locking posts 38 are inserted into the bracket 20 and the fixing holes 422 of the disk drive 40. The disk drive 40 is thus secured in the bracket 20.

In use, any vibrations generated from the disk drive 40 when operating are transferred to the locking posts 38. At this time, a joint between each locking portion 32 and corresponding locking post 38 is impacted. Because the locking posts 38 are secured to the locking portion 32, but not directly integratedly extending from the locking portion 32, the joint is more resistant to damage from impacts.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

What is claimed is:

1. A mounting apparatus comprising:
a bracket configured for receiving a disk drive, the bracket comprising a side plate, and the side plate defines two through holes; and
a locking member secured to the side plate and comprising a locking portion and two locking posts, the locking portion being resiliently deformable, and the two locking posts secured to the locking portion, the locking member having an unlocked position, where the locking portion is resiliently deformed and the two locking posts are disengaged from the bracket, and a locked position, where the locking portion is in an original state and inserts the two locking posts into the bracket through the two through holes, for engaging in fixing holes defined in the disk drive.

2. The mounting apparatus of claim 1, wherein the locking portion defines two mounting holes that receive the two locking posts.

3. The mounting apparatus of claim 2, wherein the two locking posts are secured in the two mounting holes by riveting.

4. The mounting apparatus of claim 1, wherein a convex portion is located on the locking portion between the two locking posts.

5. The mounting apparatus of claim 4, wherein the locking member further comprises an operating portion extending from the locking portion; the two locking posts are adjacent the operating portion; and the convex portion extends to the operating portion.

6. The mounting apparatus of claim 5, wherein the side plate defines two fastening holes; the locking portion defines two securing holes corresponding to the two fastening holes; and two fasteners are engaged in the corresponding two fastening holes and the two securing holes to secure the locking member to the side plate.

7. The mounting apparatus of claim 1, wherein each locking post has a circular cross-section.

8. The mounting apparatus of claim 1, wherein each locking post has a polygon cross-section.

9. A mounting apparatus comprising:
a bracket configured for receiving a disk drive, the bracket comprising a side plate, and the side plate defines a through hole; and
a locking member secured to the side plate and comprising a locking portion and a locking post, the locking portion being resiliently deformable and defining a mounting hole that receives the locking post, the locking member having an unlocked position, where the locking portion is resiliently deformed and the locking post is located for the disk drive inserting into the bracket, and a locked position, where the locking portion is in an original state and inserts the locking post into the bracket through the through hole, for engaging in a fixing hole defined in the disk drive.

10. The mounting apparatus of claim 9, wherein the locking post is secured in the mounting hole by riveting.

11. The mounting apparatus of claim 9, wherein a convex portion is located on the locking portion.

12. The mounting apparatus of claim 11, wherein the locking member further comprises an operating portion extending from the locking portion; the locking post is adjacent the operating portion; and the convex portion extends to the operating portion.

13. The mounting apparatus of claim 12, wherein the side plate defines two fastening holes; the locking portion defines two securing holes corresponding to the two fastening holes; and two fasteners are engaged in the two fastening holes and the corresponding two securing holes to secure the locking member to the side plate.

14. The mounting apparatus of claim 13, wherein the convex portion is located between the two fastening holes.

15. The mounting apparatus of claim 9, wherein the locking post has a circular cross-section.

16. The mounting apparatus of claim 9, wherein the locking post has a polygon cross-section.
